(19) United States
(12) Patent Application Publication
(10) Pub. No.: US 2004/0189586 A1
(43) Pub. Date: Sep. 30, 2004

(54) Method of driving a liquid crystal display panel and liquid crystal display device

(75) Inventor: Yoji Nagase, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 10/806,827

(22) Filed: Mar. 23, 2004

(30) Foreign Application Priority Data
Mar. 31, 2003 (JP) 2003-093267

(51) Int. Cl. G09G 3/36

(52) U.S. Cl. 345/100

(57) ABSTRACT

A method of driving a liquid crystal display panel of the type of active matrix which effects the pre-scanning and the main scanning. An improved writing efficiency is obtained by fully utilizing the effect of pre-writing to offer superior display characteristics without increasing the process load or the cost, and a liquid crystal display device. The polarity of a data signal is inverted for every horizontal scanning period. A pre-scanning period B is set five scanning periods to four scanning periods before the main scanning period A which is for writing a predetermined pixel voltage into the pixels. In the main scanning, the gate signal is raised simultaneously with the data signal and is broken down before the polarity of the data signal is inverted.

### BACKGROUND OF THE INVENTION

1. Field of the Invention

This invention relates to a method of driving a liquid crystal display panel of the type of active matrix and to a liquid crystal display device.

2. Description of the Related Art

In recent years, liquid crystal display devices of the type of active matrix have been widely used for OA equipment as represented by personal computers, and have further been realized in large sizes and in a highly sophisticated form designed for being adapted to EWSs (engineering workstations).

As the liquid crystal display devices become large in size and highly sophisticated, however, the load capacitance increases on the gate lines (scanning lines), the gate signals (scanning signals) become dull and, hence, the horizontal scanning time is substantially shortened. Therefore, an increased driving ability is urged for the TFTs (thin-film transistors) which are the switching elements.

In general, the driving ability of the TFT is achieved by improving the mobility of a-Si (amorphous silicon) forming a channel of the TFT, increasing the channel width of the TFT, shortening the channel length, and increasing the gate-on voltage of the TFT.

To improve the mobility of a-Si, however, the production process must be radically improved. Besides, an increase in the channel width of the TFT is accompanied by an increase in the parasitic capacitance and an increased probability of source-drain short circuit.

With the current photolithography technology, however, it is not easy to further shorten the channel length. A method of increasing the gate-on voltage of the TFT cannot be easily applied from the standpoint of limitation on the driver and stress affecting the TFTs.

Therefore, in order to write the data to a sufficient degree within short periods of scanning time, there has been proposed a method of pre-writing the data by applying a gate-on voltage prior to writing the data into the pixels to a predetermined voltage during the normal scanning period, instead of greatly changing the a-Si characteristics, size of the TFTs or the gate-on voltage.

According to this method, there is no problem when the data voltages have the same polarity for scanning one frame. When the polarity of the data voltage is inverted for each horizontal scanning, however, the data of the preceding scanning are read and, hence, the efficiency rather decreases.

FIG. 25 is a view schematically illustrating the constitution of a major portion of a conventional active matrix liquid crystal display device, wherein reference numeral 1 denotes an active matrix liquid crystal display panel, 2 denotes data lines for transmitting data signals and 3 denotes gate lines for transmitting gate signals. Symbol (i) denotes a circuit constitution of a pixel in the liquid crystal display panel 1, reference numeral 4 denotes a TFT that serves as a switching element, 5 denotes a pixel electrode, 6 denotes an opposing electrode, 7a denotes liquid crystals and 7b denotes a storage capacitor.

Reference numeral 8 denotes a source drive circuit for driving the source of the TFT 4 through the data line 2 by sending a data signal onto the data line 2. The source drive circuit 8 is constituted by a plurality of source driver ICs. Reference numeral 9 denotes a gate drive circuit for driving the gate of the TFT 4 through the gate line 3 by sending a gate signal onto the gate line 3. The gate drive circuit 9 is constituted by a plurality of gate driver ICs.

FIG. 26 is a diagram of voltage waveforms illustrating a method of driving the liquid crystal display panel 1, wherein reference numeral 10 denotes a data signal on the data line 2, reference numeral 11 denotes the center of the data signal 12 denotes a gate signal on the gate line 3 and 13 denotes a pixel voltage (voltage of the pixel electrode 5).

According to this driving method, the pre-writing is effected during a period B ahead of a period A which is the normal scanning period in order to enhance the writing efficiency by inverting the polarity of the data voltage for every frame. This permits the pixel voltage 13 to assume a value close to a predetermined voltage VA (VB) ahead of the normal scanning period A, and the predetermined voltage VA (VB) is reached sufficiently quickly within the normal scanning period A.

According to this driving method, therefore, the writing is finished without changing the TFTs 4 or the gate-on voltage even when the normal scanning period A is so short that the predetermined voltage cannot be written to a sufficient degree.

The conventional method of driving the liquid crystal display panel illustrated in FIG. 26 is effective in performing the so-called frame inversion driving when the data voltage has the same polarity for scanning the one frame but exhibits a decreased effect of pre-writing when the polarity of the data voltage changes for every horizontal scanning period (such as dot inversion driving method, transverse inversion driving method) since the data of the preceding horizontal scanning are read out as illustrated in FIG. 27.

Here, the data signal 10 is inverted maintaining a predetermined period (data-holding time) after the gate signal 12 has broken down at the end of the main scanning period A, so that the data of the next horizontal scanning will not be written in a state where the TFT 4 has not been turned off to a sufficient degree due to the dulled gate signal 12.

Even when the data voltage has the same polarity for the scanning of one frame, the data of the preceding horizontal scanning are read out as illustrated in FIG. 28 when there is displayed a pattern in which white and black are alternately arranged in the direction of the scanning time axis (vertical direction).

Further, the effect of pre-writing is greatly dependent on the data voltage for effecting the pre-writing. For example, when it is attempted to write all white (e.g., 64/64 gray scale) or all black (e.g., 1/64 gray scale) in the main scanning, the writing must be effected from all black to all white through the main scanning provided the data are all black or all white at the moment of effecting the pre-writing. Therefore, the efficiency decreases as compared to when the data are all white or all black in the step of pre-writing.

### SUMMARY OF THE INVENTION

In view of the above-mentioned points, therefore, it is an object of the present invention to provide a method of driving a liquid crystal display panel which features an improved writing efficiency by fully utilizing the effect of pre-writing to offer superior display characteristics without increasing the process load or the cost, and a liquid crystal display device.

According to a method of driving the liquid crystal display panel and a liquid crystal display device of the invention, a pre-scanning and a main scanning are performed to each of the horizontal lines of the active matrix liquid crystal display panel, so that the gate signal rises at a timing in the main scanning on or after a timing at which the data signal varies.

According to the present invention, the gate signal in the main scanning rises at a timing on or after a timing at which the data signal varies. Therefore, the pre-writing data voltage is not affected no matter what voltage is assumed by the data signal in the vertical direction of one pixel before. Therefore, the effect of pre-writing is fully utilized and the writing efficiency is improved without being accompanied by an increase in the process load or the cost.

### BRIEF DESCRIPTION OF THE DRAWINGS

FIG. 1 is a diagram schematically illustrating the constitution of a major portion of a liquid crystal display device according to a first embodiment of the present invention;

FIG. 2 is a diagram of voltage waveforms illustrating the first embodiment of a method of driving a liquid crystal display panel of the invention;

FIG. 3 is a diagram of voltage waveforms illustrating a second embodiment of the method of driving the liquid crystal display panel of the invention;

FIG. 4 is a diagram of voltage waveforms illustrating a concrete example of the second embodiment of the method of driving the liquid crystal display panel of the invention;

FIG. 5 is a diagram of voltage waveforms illustrating a third embodiment of the method of driving the liquid crystal display panel of the invention;

FIG. 6 is a diagram of voltage waveforms illustrating a concrete example of the third embodiment of the method of driving the liquid crystal display panel of the invention;

FIG. 7 is a diagram of voltage waveforms illustrating a fourth embodiment of the method of driving the liquid crystal display panel of the invention;

FIG. 8 is a diagram of voltage waveforms illustrating a concrete example of the fourth embodiment of the method of driving the liquid crystal display panel of the invention;

FIG. 9 is a diagram of voltage waveforms illustrating a fifth embodiment of the method of driving the liquid crystal display panel of the invention;

FIG. 10 is a diagram of voltage waveforms illustrating a method of generating gate signals used in the fifth embodiment of the method of driving the liquid crystal display panel of the invention;

FIG. 11 is a diagram of voltage waveforms illustrating a first concrete example of the fifth embodiment of the method of driving the liquid crystal display panel of the invention;

FIG. 12 is a diagram of voltage waveforms illustrating a second concrete example of the fifth embodiment of the method of driving the liquid crystal display panel of the invention;

FIG. 13 is a diagram of voltage waveforms illustrating a sixth embodiment of the method of driving the liquid crystal display panel of the invention;

FIG. 14 is a diagram of voltage waveforms illustrating a concrete example of the sixth embodiment of the method of driving the liquid crystal display panel of the invention;

FIG. 15 is a diagram of voltage waveforms illustrating a seventh embodiment of the method of driving the liquid crystal display panel of the invention;

FIG. 16 is a flowchart illustrating a method of generating pre-writing data voltage used in the seventh embodiment of the method of driving the liquid crystal display panel of the invention;

FIG. 17 is a diagram of voltage waveforms illustrating an eighth embodiment of the method of driving the liquid crystal display panel of the invention;

FIG. 18 is a flowchart illustrating a method of generating pre-writing data voltage used in the eighth embodiment of the method of driving the liquid crystal display panel of the invention;

FIG. 19 is a diagram schematically illustrating the constitution of a major portion of the second embodiment of the liquid crystal display device of the invention;

FIG. 20 is a circuit diagram illustrating the constitution of a gate-on voltage change-over circuit possessed by the second embodiment of the liquid crystal display device of the invention;

FIG. 21 is a diagram of voltage waveforms illustrating a ninth embodiment of the method of driving the liquid crystal display panel of the invention;

FIG. 22 is a diagram of voltage waveforms illustrating a tenth embodiment of the method of driving the liquid crystal display panel of the invention;

FIG. 23 is a diagram of voltage waveforms illustrating an eleventh embodiment of the method of driving the liquid crystal display panel of the invention;

FIG. 24 is a diagram of voltage waveforms illustrating a method of generating gate signals used in the eleventh embodiment of the method of driving the liquid crystal display panel of the invention;

FIG. 25 is a diagram schematically illustrating the constitution of a major portion of a conventional liquid crystal display device;

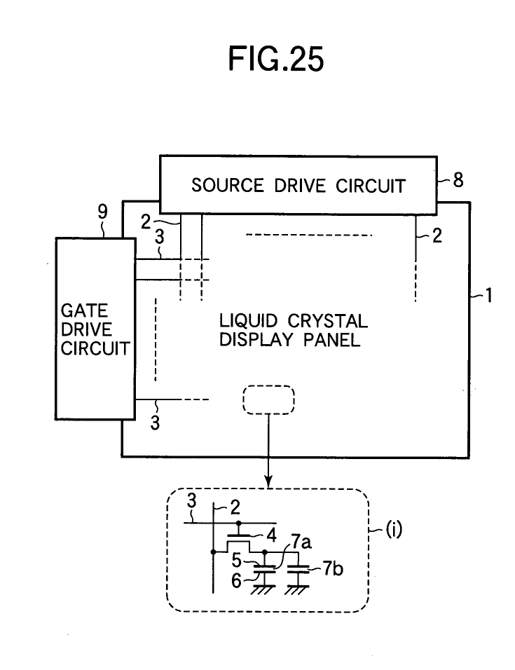

FIG. 26 is a diagram of voltage waveforms illustrating a conventional method of driving the liquid crystal display panel;

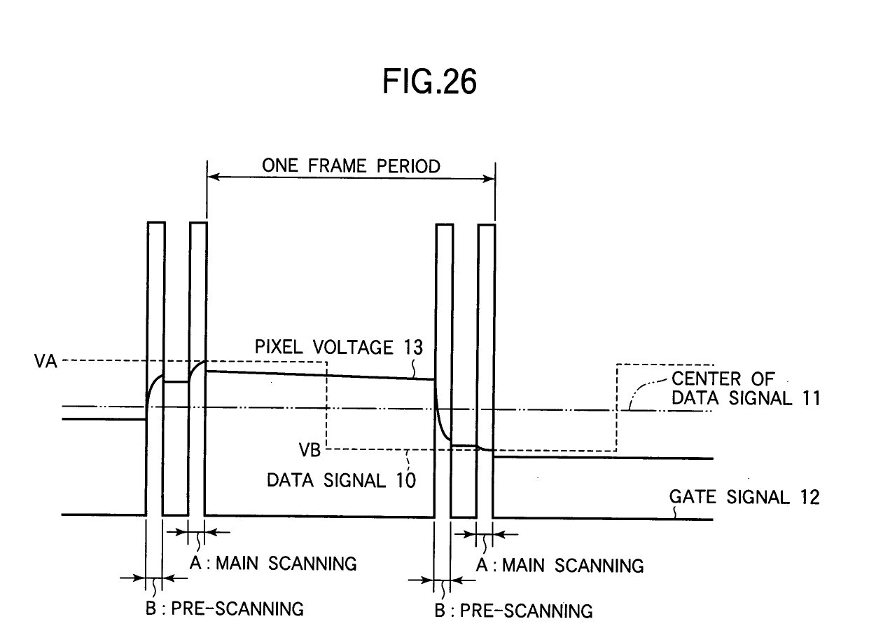

FIG. 27 is a diagram of voltage waveforms illustrating a problem possessed by the conventional method of driving the liquid crystal display panel of FIG. 26; and

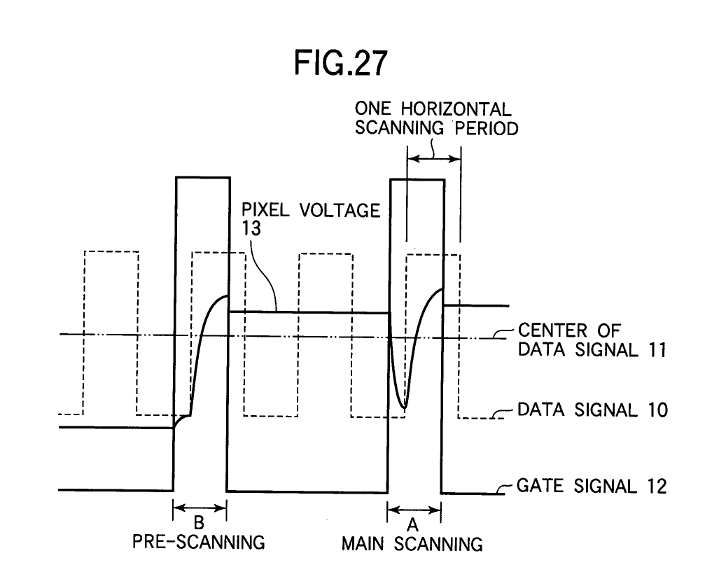

FIG. 28 is a diagram of voltage waveforms illustrating a problem possessed by the conventional method of driving the liquid crystal display panel of FIG. 26.

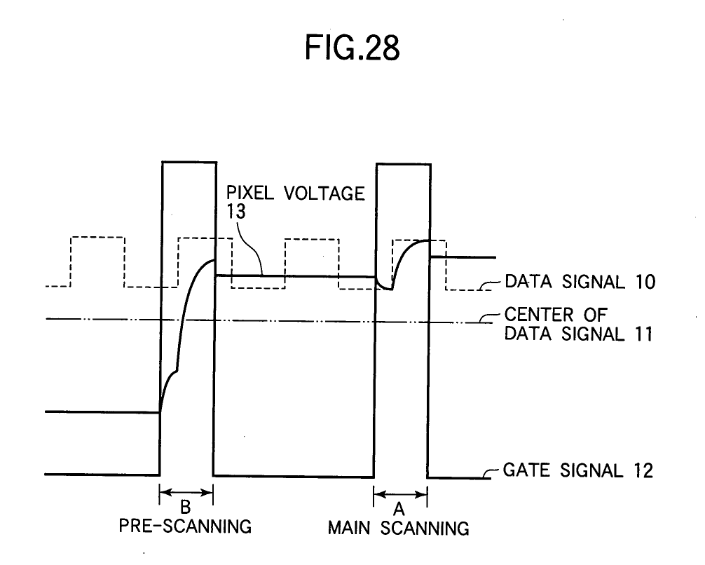

### DESCRIPTION OF THE PREFERRED EMBODIMENTS

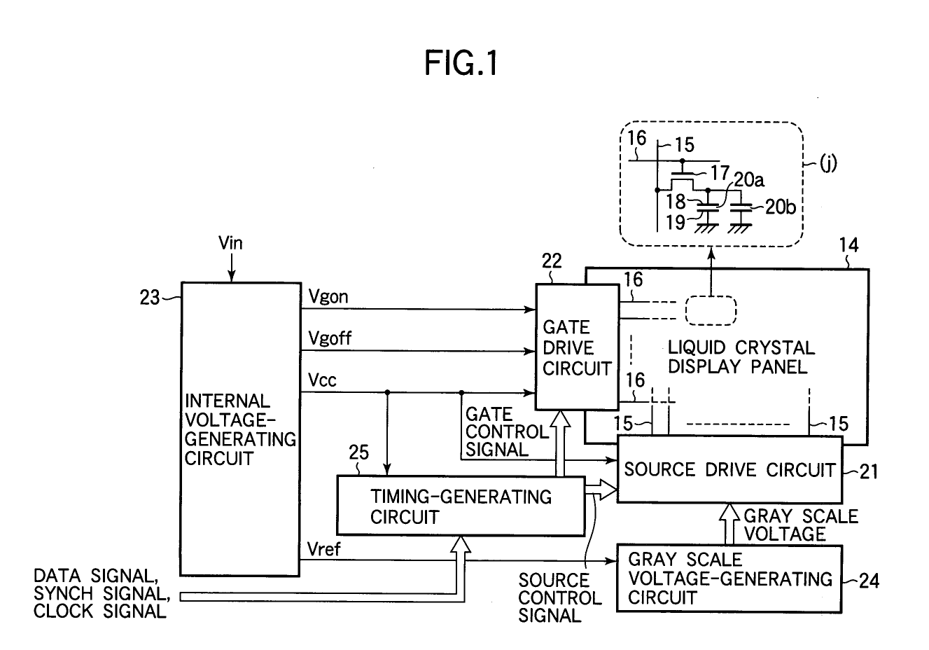

First and second embodiments of the liquid crystal display device of the invention and first to eleventh embodiments of the method of driving the liquid crystal display panel of the invention will now be described with reference to FIGS. 1 to 24.

### Liquid Crystal Display Device According to a First Embodiment of the Invention

FIG. 1 is a diagram schematically illustrating the constitution of a major portion of a liquid crystal display device according to a first embodiment of the present invention. The first embodiment of the liquid crystal display device of the invention executes the first to eighth embodiments of the method of driving the liquid crystal display panel of the invention.

In FIG. 1, reference numeral 14 denotes an active matrix liquid crystal display panel, 15 denotes data lines for transmitting analog data signals and 16 denotes gate lines for transmitting gate signals (scanning signals). Symbol (j) denotes a circuit constitution of a pixel in the liquid crystal display panel 14, reference numeral 17 denotes a TFT that serves as a switching element, 18 denotes a pixel electrode, 19 denotes an opposing electrode, 20a denotes liquid crystals and 20b denotes a storage capacitor.

Reference numeral 21 denotes a source drive circuit for driving the source of the TFT 17 through the data line 15 by sending a data signal onto the data line 15. The source drive circuit 21 is constituted by a plurality of source driver ICs. Reference numeral 22 denotes a gate drive circuit for driving the gate of the TFT 17 through the gate line 16 by sending a gate signal onto the gate line 16. The gate drive circuit 22 is constituted by a plurality of gate driver ICs.

Reference numeral 23 denotes an internal voltage-generating circuit for generating an internal power-source voltage Vcc, a reference voltage Vref, a gate-on voltage Vgon (e.g., 30 V) and a gate-off voltage Vgoff (e.g., −5 V) from an input power source Vin, and reference numeral 24 denotes a gray scale voltage-generating circuit that receives a reference voltage Vref output from the internal voltage-generating circuit 23, generates a gray scale voltage and feeds it to the source drive circuit 21.

Reference numeral 25 denotes a timing-generating circuit that receives data signals, synchronizing signals and clock signals from a data signal source (e.g., personal computer), feeds data signals and control signals to the source drive circuit 21, and feeds control signals to the gate drive circuit 22.

In the liquid crystal display device of the first embodiment of the present invention, the liquid crystal display panel 14 is driven by the method of driving the liquid crystal display panel according to the first to eighth embodiments of the invention described below. The liquid crystal display device according to the first embodiment of the invention has a feature in this respect.

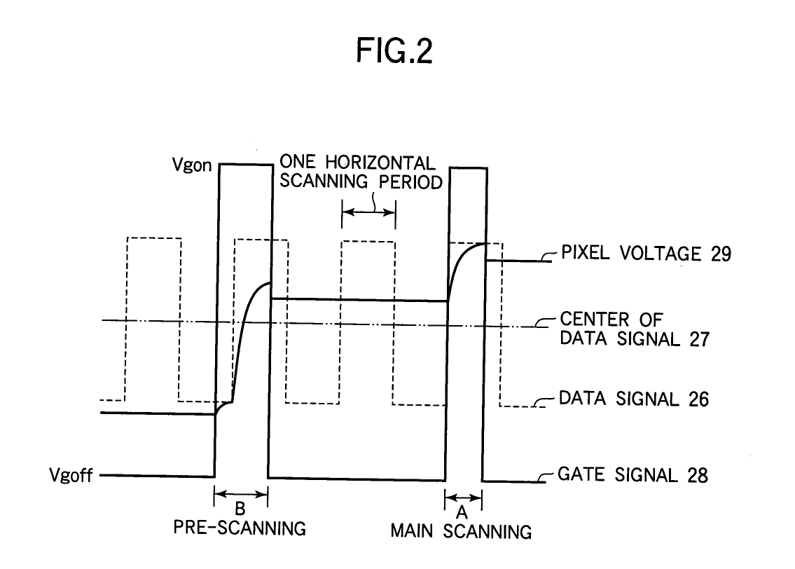

### First Embodiment of the Method of Driving the Liquid Crystal Display Panel of the Invention: FIG. 2

FIG. 2 is a diagram of voltage waveforms illustrating a first embodiment of the method of driving the liquid crystal display panel of the invention. In FIG. 2, reference numeral 26 denotes a data signal on the data line 15, reference numeral 27 denotes the center of the data signal, 28 denotes a gate signal on the gate line 16 and 29 denotes a pixel voltage (voltage of the pixel electrode 18).

In this embodiment, the polarity of the data signal 26 is inverted for every horizontal scanning period. Then, a pre-scanning period B is set five scanning periods to four scanning periods before the main scanning period A which is for writing a predetermined pixel voltage into the pixels.

In the pre-scanning, the gate signal 28 is raised prior to raising the data signal 26 and is broken down before the polarity of the data signal 26 is inverted. In the main scanning, the gate signal 28 is raised simultaneously with the data signal 26 and is broken down before the polarity of the data signal 26 is inverted.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

Here, in the pre-scanning, too, the effect of pre-writing can be expected even when the gate signal 28 is raised simultaneously with the rise of the data signal 26 like in the main scanning or slightly behind thereof. However, the efficiency is improved when the gate signal 28 assumes the on-voltage as earlier as possible. In the pre-scanning of this embodiment, therefore, the gate signal 28 is raised earlier than the rise of the data signal 26.

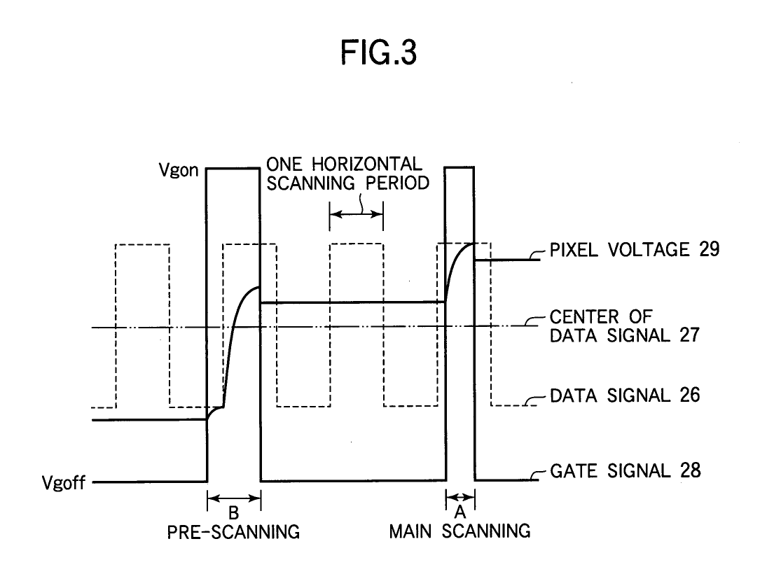

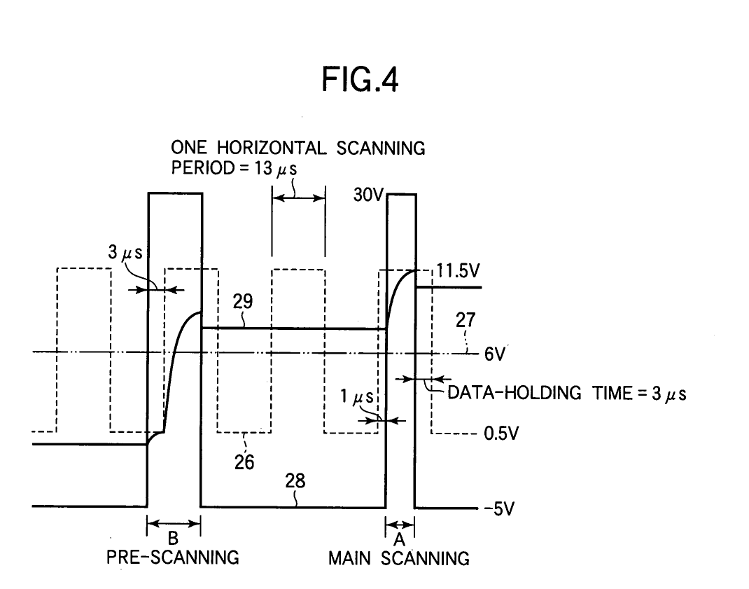

### Second Embodiment of the Method of Driving the Liquid Crystal Display Panel of the Invention: FIGS. 3 and 4

FIG. 3 is a diagram of voltage waveforms illustrating a second embodiment of the method of driving the liquid crystal display panel of the invention. In this embodiment, the polarity of the data signal 26 is inverted for every horizontal scanning period. Then, a pre-scanning period B is set five scanning periods to four scanning periods before the main scanning period A which is for writing a predetermined pixel voltage into the pixels.

In the pre-scanning, the gate signal 28 is raised prior to raising the data signal 26 and is broken down before the polarity of the data signal 26 is inverted. In the main scanning, the gate signal 28 is raised after the data signal 26 is raised and is broken down before the polarity of the data signal 26 is inverted.

According to this embodiment, the gate signal 28 is raised after the data signal 26 is raised in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost. having a resolution UXGA (1200 longitudinal pixels×1600 transverse pixels). In this case, one horizontal scanning period is about 13 μs. The data-holding time varies depending upon the load on the gate line 16 and, in this concrete example, is about 30 μs. The gate-on voltage is about 3 V, and the gate-off voltage during the data voltage-holding period is about −5 V.

The liquid crystals are of the so-called normally black (NB) type. The all-white data signal voltage is about 11 V, the all-black data signal voltage is about 1.5 V and the center of data signals is about 6 V. FIG. 4 illustrates an example in which the display pattern is all white over the whole screen.

In the pre-scanning, the gate signal 28 is raised about 3 μs earlier than the data signal and in the main scanning, the gate signal 28 is raised about 1 μs behind the data signal.

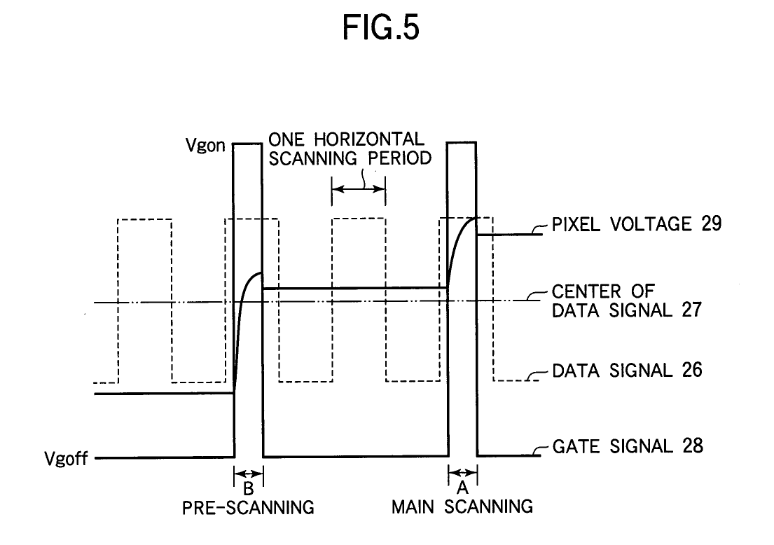

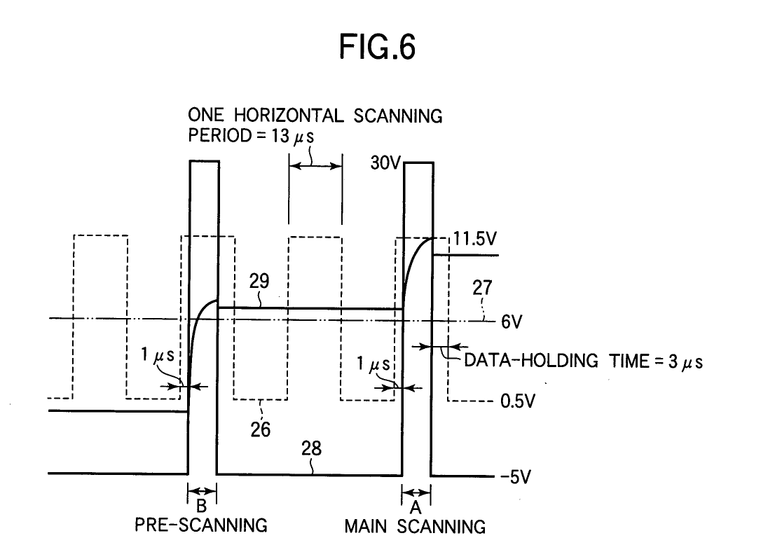

### Third Embodiment of the Method of Driving the Liquid Crystal Display Panel of the Invention: FIGS. 5 and 6

FIG. 5 is a diagram of voltage waveforms illustrating a third embodiment of the method of driving the liquid crystal display panel of the invention. In this embodiment, the polarity of the data signal 26 is inverted for every horizontal scanning period. Then, a pre-scanning period B is set four scanning periods before the main scanning period A which is for writing a predetermined pixel voltage into the pixels. In the pre-scanning and in the main scanning, the gate signal 28 is raised after the data signal 26 is raised and is broken down before the polarity of the data signal 26 is inverted.

According to this embodiment, the gate signal 28 is raised after the data signal 26 is raised in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

In the pre-scanning, too, the gate signal 28 is raised after the data signal 26 is raised. Therefore, though the efficiency of pre-writing is slightly deteriorated as compared to that of the driving method illustrated in FIG. 3, the timing of the gate signal 28 with respect to the data signal 26 is the same in the pre-scanning as well as in the main scanning making it possible to simplify the circuit.

FIG. 6 illustrates a concrete example of the embodiment having a resolution UXGA (1200 longitudinal pixels×1600 transverse pixels) like in the concrete example illustrated in FIG. 4. In this concrete example, the gate signal 28 in the pre-scanning is raised about 1 μs behind the data signal 26 like in the main scanning. In other respects, this concrete example is the same as the concrete example of FIG. 4.

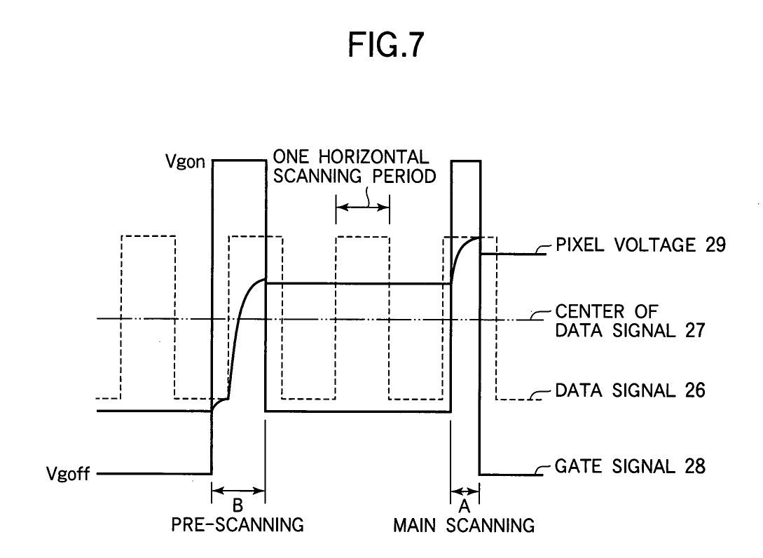

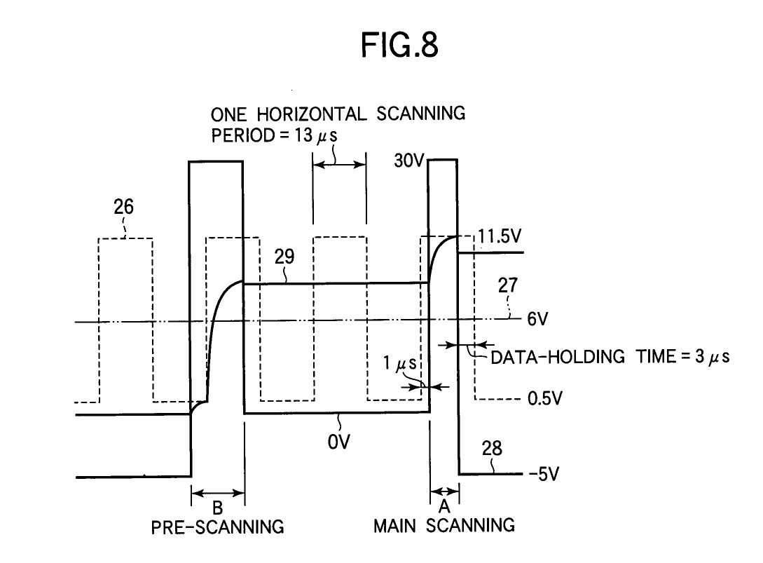

### Fourth Embodiment of the Method of Driving the Liquid Crystal Display Panel of the Invention: FIGS. 7 and 8

FIG. 7 is a diagram of voltage waveforms illustrating a fourth embodiment of the method of driving the liquid crystal display panel of the invention. In this embodiment, the polarity of the data signal 26 is inverted for every horizontal scanning period. Then, a pre-scanning period B is set five scanning periods to four scanning periods before the main scanning period A which is for writing a predetermined pixel voltage into the pixels.

In the pre-scanning, the gate signal 28 is raised prior to raising the data signal 26 and is broken down before the polarity of the data signal 26 is inverted. In the main scanning, the gate signal 28 is raised after the data signal 26 is raised and is broken down before the polarity of the data signal 26 is inverted. Further, the gate-off voltage after the pre-scanning is set to be higher than the gate-off voltage during the data voltage-holding period after the main scanning. In the main scanning, the gate signal 28 may be raised simultaneously with the data signal 26.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

Further, the gate-off voltage after the pre-scanning is set to be higher than the gate-off voltage during the data voltage-holding period after the main scanning making it possible to decrease the amount of change ΔVs in the pixel voltage 29 after the pre-writing. In this regard, too, the writing efficiency can be improved.

Here, the amount of change ΔVs in the pixel voltage 29 after the pre-writing represents a magnitude of change in the pixel voltage produced by the propagation of a change in the gate signal 28 due to parasitic capacitance between the gate of the TFT 17 and the pixel electrode 18, and varies in proportion to the magnitude of the break-down voltage of the gate signal 28.

In this embodiment, therefore, the break down of the gate signal 28 at the end of the pre-writing is decreased to decrease the amount of change ΔVs in the pixel voltage 29 thereby to decrease a difference between the pixel voltage 29 after the pre-writing and the data voltage written in the main scanning to improve the writing efficiency.

FIG. 8 illustrates a concrete example of the embodiment having a resolution UXGA (1200 longitudinal pixels×1600 transverse pixels) like in the concrete example of FIG. 4. In this concrete example, the gate-off voltage after the pre-scanning is 0 V and the voltage during the data voltage-holding period after the main scanning is about −5 V. In other respects, this concrete example is the same as the concrete example illustrated in FIG. 4.

In the pre-scanning, too, the gate signal 28 may be raised simultaneously with the data signal 26 and may be broken down before the polarity of the data signal 26 is inverted like in the main scanning.

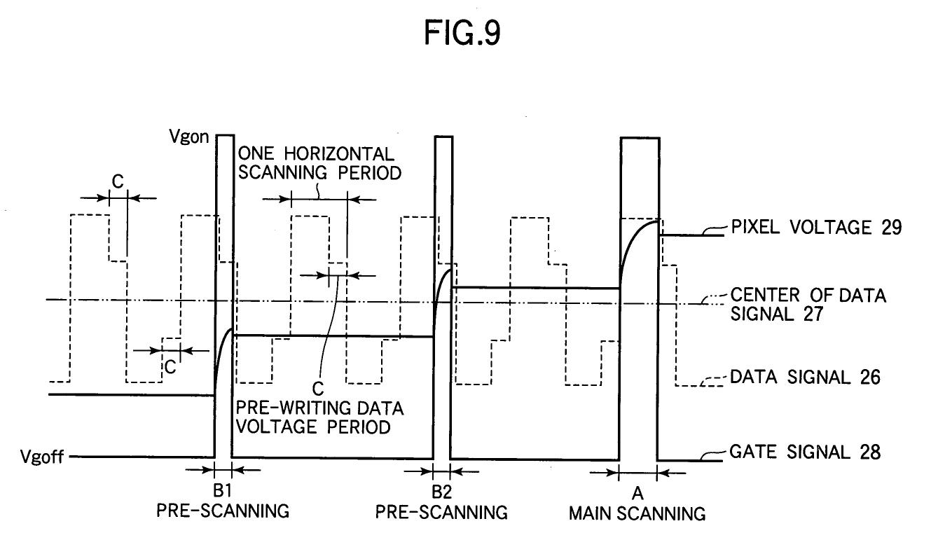

### Fifth Embodiment of the Method of Driving the Liquid Crystal Display Panel of the Invention: FIGS. 9 to 12

FIG. 9 is a diagram of voltage waveforms illustrating a fifth embodiment of the method of driving the liquid crystal display panel of the invention. In this embodiment, the polarity of the data signal 26 is inverted for every horizontal scanning period, and the data voltage is maintained at a display voltage for a predetermined period of time after the inversion of the polarity but, after the passage of the predetermined period of time from the inversion of polarity, a pre-writing data voltage period C is imparted to maintain a voltage of an intermediate gray scale at all times irrespective of the display voltage.

Then, two times of pre-scanning periods B1 and B2 are set even numbers of scanning periods before the main scanning period A. For example, the pre-scanning periods B1 and B2 are set eight scanning periods and four scanning periods before the main scanning period A.

In the pre-scanning, the gate signal 28 is raised before and after the start of the pre-writing data voltage period C, and is broken down before the end of the pre-writing data voltage period C. In the main scanning, the gate signal 28 is raised simultaneously with the data signal 26 and is broken down before the pre-writing data voltage period C starts.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

The same effect can be expected at all times since the pre-writing data voltage does not depend on the display pattern. Provision of the pre-writing data voltage period C shortens the period that can be utilized for the main scanning. However, there is no problem since the pre-writing effect is improved by providing two times of pre-scanning periods B1 and B2.

The pre-writing data voltage may be determined as required between all white and all black. If, for example, panel brightness characteristics are taken into consideration, the data voltage may be set to be corresponded to the intermediate gray scale. If importance is given to a voltage value, the data voltage may be set to be a mean value of data voltages of all white and all black.

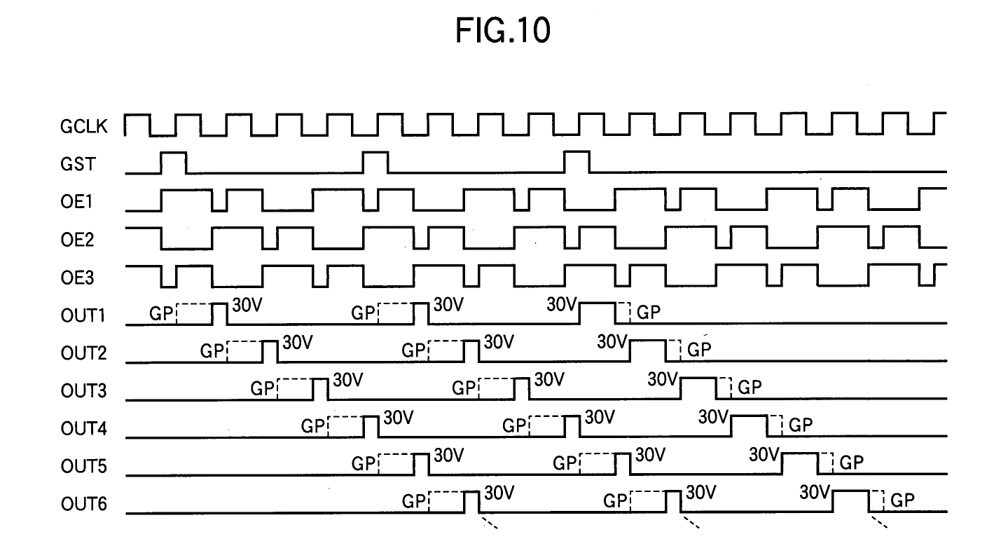

FIG. 10 is a diagram of voltage waveforms illustrating a method of generating gate signals used for the embodiment, wherein GCLK, GST and OE1 to OE3 are signals fed to the gate drive circuit 22 from the timing-generating circuit 25, GCLK being a gate clock signal, GST being a start signal and OE1 to OE3 being output enable signals. OUT1 to OUT6 are gate signals output to gate lines 16 of from a first horizontal line up to a sixth horizontal line.

Namely, in this embodiment, the gate drive circuit 22 produces three gate signal-generating signals GP maintaining an interval of three horizontal scanning periods and being delayed by a horizontal period behind the gate signal-generating signals GP of the preceding horizontal lines, the gate signal-generating signals GP being corresponded to the first, second, - - - and m-th (e.g., 1200) horizontal lines, having an H-level voltage as a gate-on voltage (30 V) and having an H-level pulse width as a period of the gate clock signal GCLK.

In the first, fourth, - - - and 3N+1 horizontal lines, the H-level of the gate signal-generating signals GP is set to be Vgoff using the H-level of the output enable signal OE1 to thereby generate the gate signals 28. In the second, fifth, - - - and 3N+2 horizontal lines, the H-level of the gate signal-generating signals GP is set to be Vgoff using the H-level of the output enable signal OE2 to thereby generate the gate signals 28. In the third, sixth, - - - and 3N+3 horizontal lines, the H-level of the gate signal-generating signals GP is set to be Vgoff using the H-level of the output enable signal OE3 to thereby generate the gate signals 28.

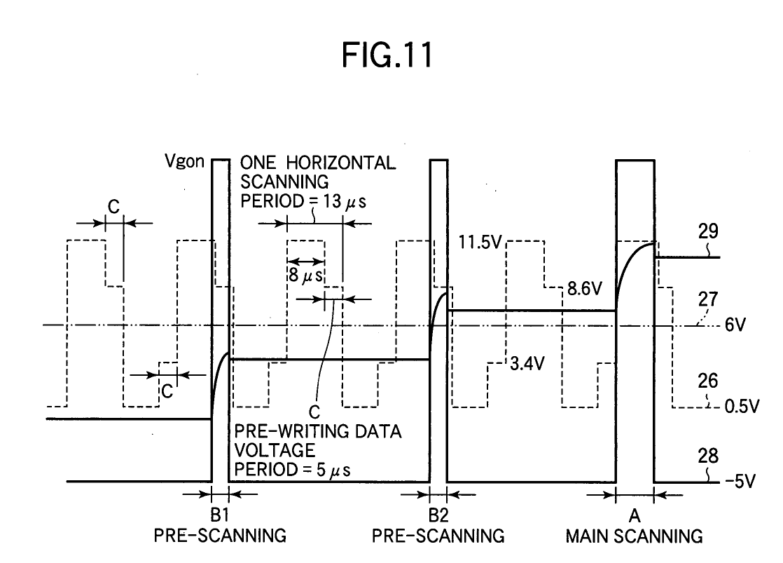

FIG. 11 illustrates a first concrete example of the embodiment and deals with a case having a resolution UXGA (longitudinal 1200 pixels× transverse 1600 pixels) like in the concrete example of FIG. 4. In this concrete example, the data signal 26 inverts the polarity for every horizontal scanning period. After about 8 μs from the inversion, the pre-writing data voltage period C begins.

Due to the characteristics of the liquid crystals, the data voltage for displaying the intermediate gray scale does not necessarily lie midway between the all white data voltage and the all black data voltage. Generally, it is closer to the all black data voltage than the middle between the all white data voltage and the all black data voltage. In this concrete example, the pre-writing data voltage is +8.6 V/+3.4 V.

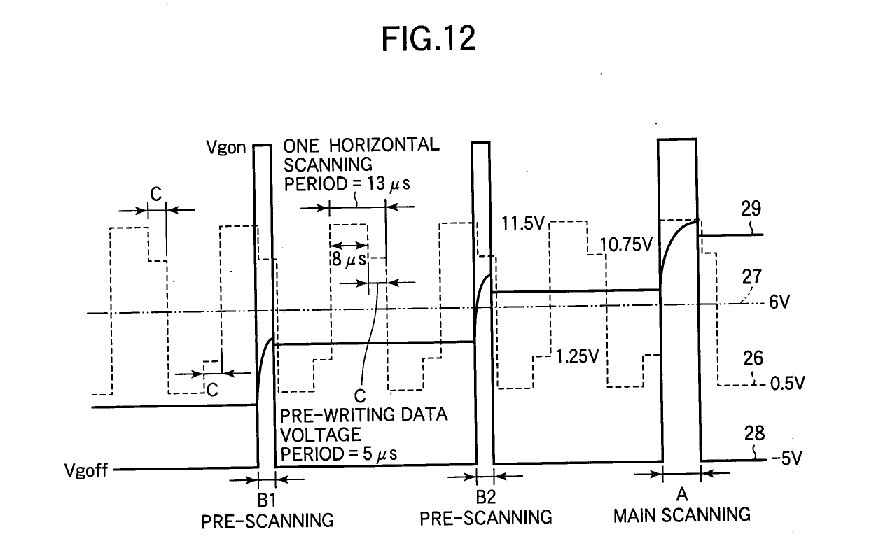

FIG. 12 illustrates a second concrete example of the embodiment and deals with a case having a resolution UXGA (longitudinal 1200 pixels×transverse 1600 pixels) like in the concrete example of FIG. 4. In this concrete example, the pre-writing data voltage is +10.75 V/+1.25 V which is nearly an intermediate voltage between the all white voltage and the all black voltage.

The gate-off voltage between the second pre-scanning period B2 and the main scanning period A may be set to be higher than the gate-off voltage during the data voltage-holding period after the main scanning period A.

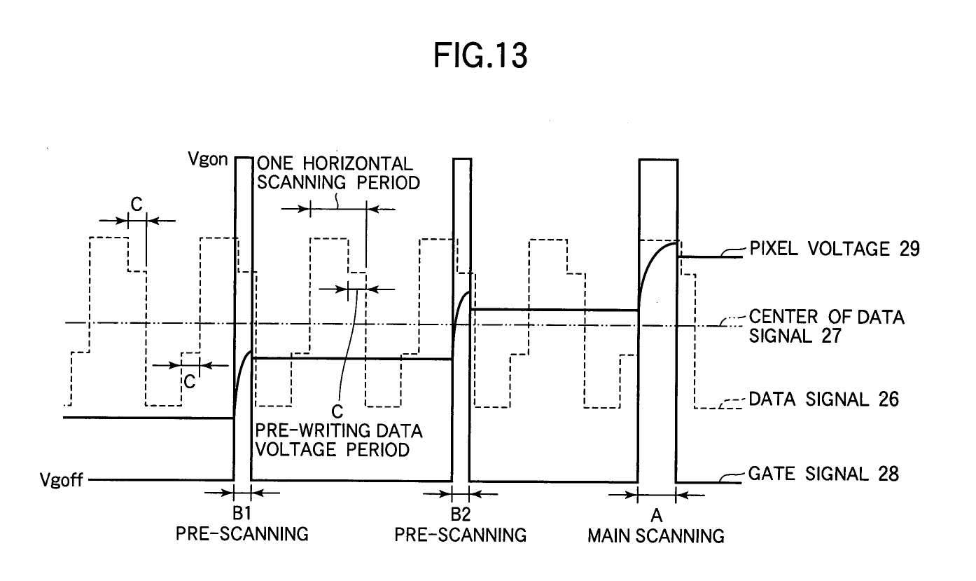

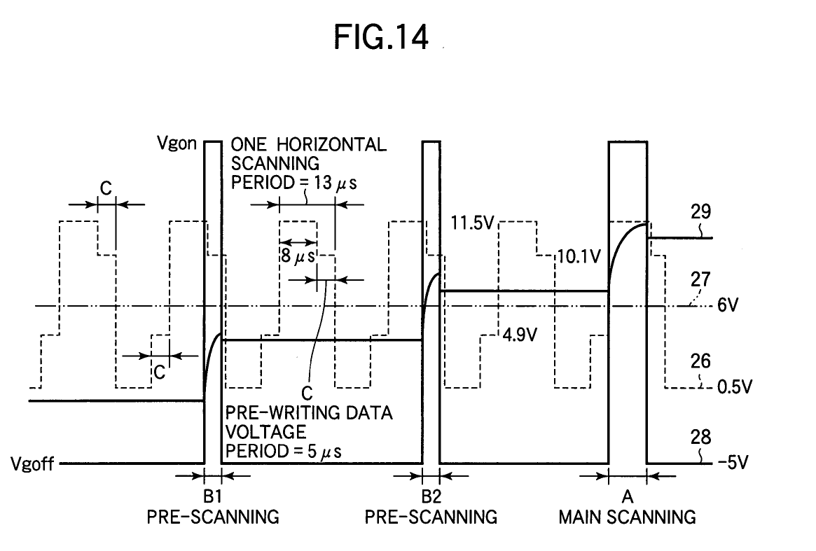

### Sixth Embodiment of the Method of Driving the Liquid Crystal Display Panel of the Invention: FIGS. 13 and 14

FIG. 13 is a diagram of voltage waveforms illustrating a sixth embodiment of the method of driving the liquid crystal display panel of the invention. In this embodiment, the polarity of the data signal 26 is inverted for every horizontal scanning period, and the data voltage is maintained at a display voltage for a predetermined period of time after the inversion of the polarity but, after the passage of the predetermined period of time from the inversion of polarity, a pre-writing data voltage period C is imparted to maintain a predetermined writing data voltage at all times irrespective of the display voltage.

The pre-writing data voltage is higher by ΔVs (amount of change in the pixel voltage 29 after the pre-writing) than the “data voltage of intermediate gray scale”, “average value of all white and all black data voltages” and “gray scale data voltage same as the display gray scale in the main scanning” or “data voltage of average gray scale of pixels along the data line of one frame”.

Then, two times of pre-scanning periods B1 and B2 are set even numbers of scanning periods before the main scanning period A. For example, the pre-scanning periods B1 and B2 are set eight scanning periods and four scanning periods before the main scanning period A.

In the pre-scanning, the gate signal 28 is raised before and after the start of the pre-writing data voltage period C, and is broken down before the end of the pre-writing data voltage period C. In the main scanning, the gate signal 28 is raised simultaneously with the data signal 26, and is broken down before the pre-writing data voltage period C starts.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

In this embodiment, further, the pre-writing data voltage is set to be higher by ΔVs (amount of change in the pixel voltage 29 after the pre-writing) than the “data voltage of intermediate gray scale” and, hence, the pre-writing efficiency can be improved.

FIG. 14 illustrates a concrete example of the embodiment and deals with a case having a resolution UXGA (longitudinal 1200 pixels×transverse 1600 pixels) like in the concrete example of FIG. 4. The pre-writing data voltage is +10.1 V/+4.9 V which is nearly an intermediate voltage between the all white voltage and the all black voltage.

Here, the gate-off voltage between the second pre-scanning period B2 and the main scanning period A may be set to be higher than the gate-off voltage during the data voltage-holding period after the main scanning period A.

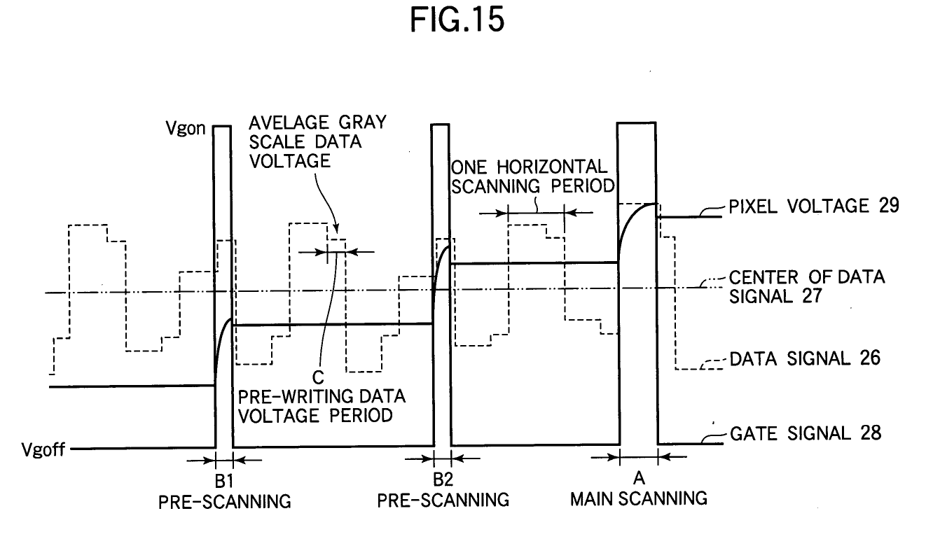

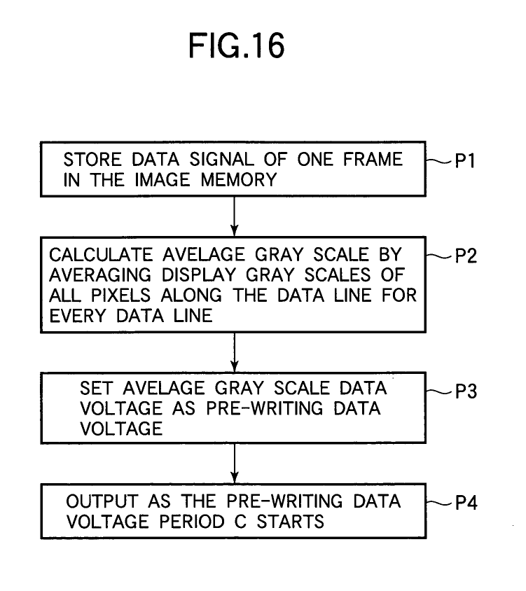

### Seventh Embodiment of the Method of Driving the Liquid Crystal Display Panel of the Invention: FIGS. 15 and 16

FIG. 15 is a diagram of voltage waveforms illustrating a seventh embodiment of the method of driving the liquid crystal display panel of the invention. In this embodiment, the polarity of the data signal 26 is inverted for every horizontal scanning period, and the data voltage is maintained at a display voltage for a predetermined period of time after the inversion of the polarity but, after the passage of the predetermined period of time from the inversion of polarity, a pre-writing data voltage period C is imparted to maintain a predetermined writing data voltage at all times irrespective of the display voltage. The pre-writing data voltage is an average value of display voltages of all pixels along the data line for each of the frames and for each of the data lines.

Then, two times of pre-scanning periods B1 and B2 are set even numbers of scanning periods before the main scanning period A. For example, the pre-scanning periods B1 and B2 are set eight scanning periods and four scanning periods before the main scanning period A.

In the pre-scanning, the gate signal 28 is raised before and after the start of the pre-writing data voltage period C, and is broken down before the end of the pre-writing data voltage period C. In the main scanning, the gate signal 28 is raised simultaneously with the data signal 26, and is broken down before the pre-writing data voltage period C starts.

FIG. 16 is a flowchart illustrating a method of generating the pre-writing data voltage used in the embodiment. To execute this embodiment, the liquid crystal display device of the first embodiment of the invention is provided with an image memory for storing data signals of one frame, and the data signals of one frame are stored in the image memory (step P1).

Next, an arithmetic unit calculates an average gray scale by averaging display gray scales of all pixels along the data line for each of the data lines by using data signals in the image memory (step P2), sets a data voltage corresponding to the calculated average gray scale to be a pre-writing data voltage (step P3) and outputs it as the pre-writing data voltage period C starts (step P4).

Here, the average value is obtained by averaging all gray scales irrespective of the polarity of the data, or by separately calculating average gray scales of the data of positive polarity and those of the data of negative polarity, and using the data of respective polarities as the pre-writing data voltages. Any method may be selected by taking the effect and the cost of the necessary circuitry into consideration.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

Here, the gate-off voltage between the second pre-scanning period B2 and the main scanning period A may be set to be higher than the gate-off voltage during the data voltage-holding period after the main scanning period A.

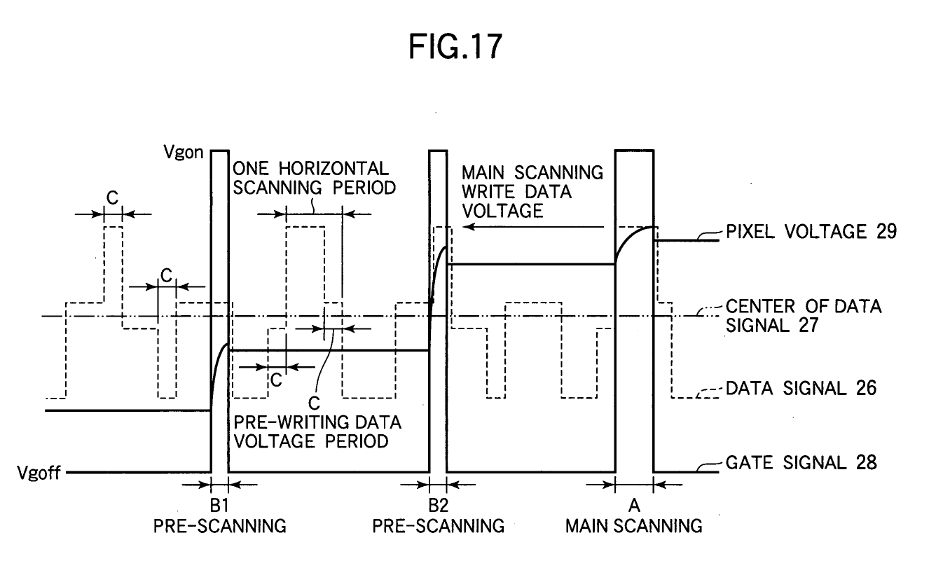

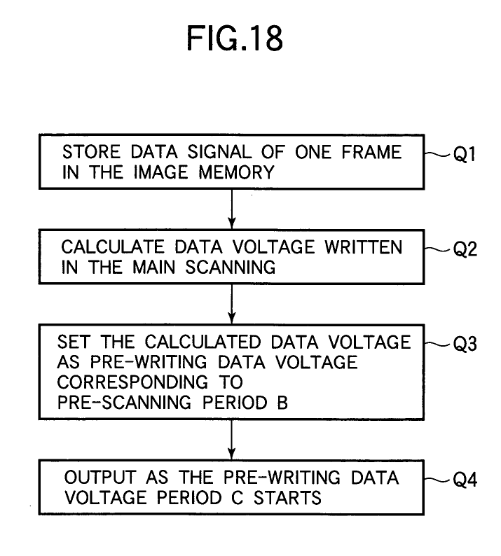

### Eighth Embodiment of the Method of Driving the Liquid Crystal Display Panel of the Invention: FIGS. 17 and 18

FIG. 17 is a diagram of voltage waveforms illustrating an eighth embodiment of the method of driving the liquid crystal display panel of the invention. In this embodiment, the polarity of the data signal 26 is inverted for every horizontal scanning period, and the data voltage is maintained at a display voltage for a predetermined period of time after the inversion of the polarity but, after the passage of the predetermined period of time from the inversion of polarity, a pre-writing data voltage period C is imparted to maintain a predetermined writing data voltage at all times.

Then, two times of pre-scanning periods B1 and B2 are set even numbers of scanning periods before the main scanning period A. For example, the pre-scanning periods B1 and B2 are set eight scanning periods and four scanning periods before the main scanning period A.

In the pre-scanning, the gate signal 28 is raised before and after the start of the pre-writing data voltage period C, and is broken down before the end of the pre-writing data voltage period C. In the main scanning, the gate signal 28 is raised simultaneously with the data signal 26, and is broken down before the pre-writing data voltage period C starts.

According to this embodiment, the pre-writing data voltage to be written during the pre-scanning period B is the same as the data voltage in the main scanning. FIG. 18 is a flowchart illustrating a method of generating a pre-writing data voltage to be written in the pre-scanning period B2.

To execute this embodiment, the liquid crystal display device of the first embodiment of the invention is provided with an image memory for storing data signals of one frame, and the data signals of one frame are stored in the image memory (step Q1).

Next, an arithmetic unit calculates a data voltage written in the main scanning by using data signals in the image memory (step Q2), sets the calculated data voltage to be a pre-writing data voltage corresponding to the pre-scanning period B (step Q3) and outputs it as the pre-writing data voltage period C starts (step Q4).

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

Here, the gate-off voltage between the second pre-scanning period B2 and the main scanning period A may be set to be higher than the gate-off voltage during the data voltage-holding period after the main scanning period A.

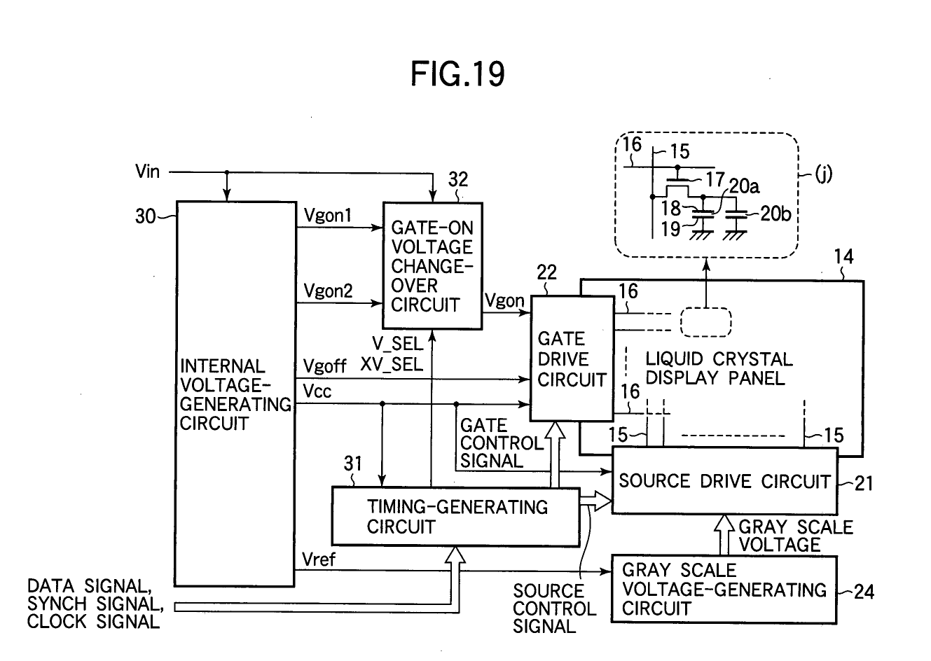

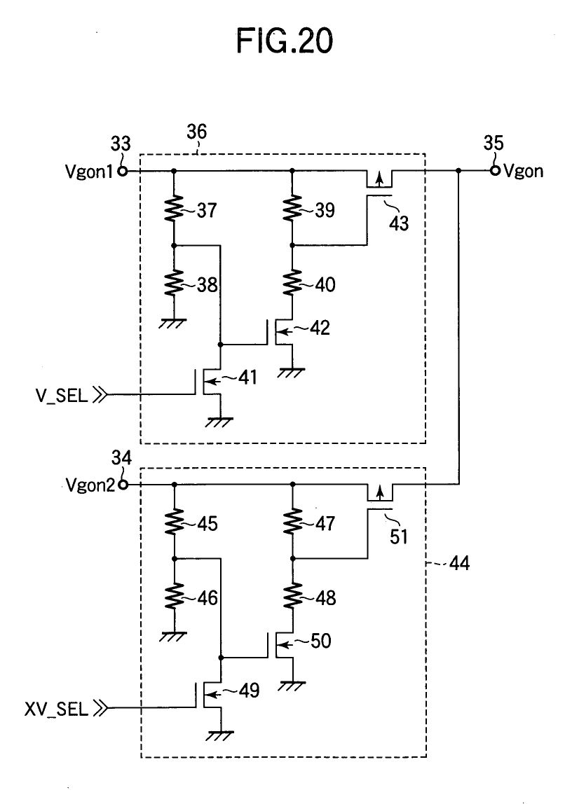

### Liquid Crystal Display Device According to a Second Embodiment of the Invention: FIGS. 19 and 20

FIG. 19 is a diagram schematically illustrating the constitution of a major portion of the liquid crystal display device according to a second embodiment of the present invention, and is a circuit diagram illustrating the major portion of the liquid crystal display device for executing the ninth to eleventh embodiments of the method of driving the liquid crystal display panel of the invention.

The liquid crystal display device according to the second embodiment of the invention is provided with an internal voltage-generating circuit 30 and a timing-generating circuit 31 having functions different from those of the internal voltage-generating circuit 23 and the timing-generating circuit 25 possessed by the liquid crystal display device of the first embodiment of the invention illustrated in FIG. 1, and with a gate-on voltage change-over circuit 32. In other respects, the liquid crystal display device of the second embodiment is constituted in the same manner as the liquid crystal display device of the first embodiment of the invention illustrated in FIG. 1.

The internal voltage-generating circuit 30 generates an internal power-source voltage Vcc, a reference voltage Vref, gate-on voltages Vgon1 (e.g., 20 V) , Vgon2 (e.g., 30 V) and a gate-off voltage Vgoff (e.g., −5 V) from an input power source Vin.

The timing-generating circuit 31 receives data signals, synchronizing signals and clock signals from a data signal source (e.g., personal computer), feeds data signals and control signals to the source drive circuit 21, feeds control signals to the gate drive circuit 22, feeds control signals to the gate drive circuit 22, and feeds gate-on voltage change-over signals V_SEL and XV_SEL to the gate-on voltage change-over circuit 32.

The gate-on voltage change-over circuit 32 receives a gate-on voltage Vgon1 or Vgon2 output from the internal voltage-generating circuit 30, and feeds either one of them as a gate-on voltage Vgon to the gate drive circuit 22.

FIG. 20 is a circuit diagram illustrating the constitution of the gate-on voltage change-over circuit 32, wherein reference numeral 33 denotes an input node for gate-on voltage Vgon1, 34 denotes an input node for Vgon2 and 35 denotes an output node for gate-on voltage Vgon.

Reference numeral 36 denotes a switching circuit that corresponds to the gate-on voltage Vgon1, 37 to 40 denote resistors, 41 and 42 denote NMOS transistors and 43 denotes a PMOS transistor. Reference numeral 44 denotes a switching circuit corresponding to the gate-on voltage Vgon2, 45 to 48 denote resistors, 49 and 50 denote NMOS transistors and 51 denotes a PMOS transistor.

In the thus constituted gate-on voltage change-over circuit 32, when the gate-on voltage change-over signals have a V_SEL=L level and an XV_SEL=H level, the NMOS transistor 41 is off, the NMOS transistor 42 is on and the PMOS transistor 43 is on in the switching circuit 36.

In the switching circuit 44, on the other hand, the NMOS transistor 49 is on, the NMOS transistor 50 is off and the PMOS transistor 51 is off. In this case, therefore, the gate-on voltage Vgon1 is fed as a gate-on voltage Vgon to the gate drive circuit 22.

Conversely, when the gate-on voltage change-over signals have the V_SEL=H level and the XV_SEL=L level, the NMOS transistor 41 is on, the NMOS transistor 42 is off and the PMOS transistor 43 is off in the switching circuit 36.

In the switching circuit 44, on the other hand, the NMOS transistor 49 is off, the NMOS transistor 50 is on and the PMOS transistor 51 is on. In this case, therefore, the gate-on voltage Vgon2 is fed as a gate-on voltage Vgon to the gate drive circuit 22.

In the liquid crystal display device of the second embodiment of the present invention, the liquid crystal display panel 14 is driven by the method of driving the liquid crystal display panel according to ninth to eleventh embodiments of the invention described below. The liquid crystal display device according to the second embodiment of the invention has a feature in this respect.

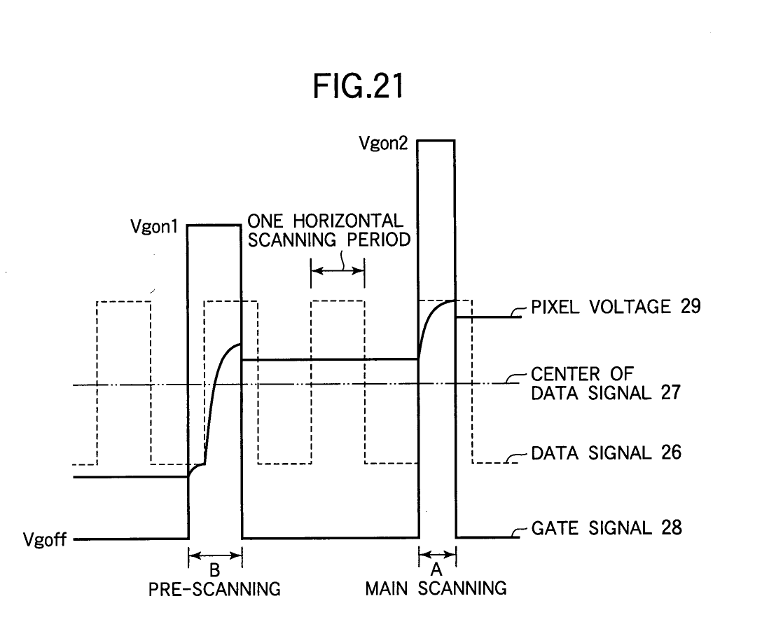

### Ninth Embodiment of the Method of Driving the Liquid Crystal Display Panel of the Invention: FIG. 21

FIG. 21 is a diagram of voltage waveforms illustrating a ninth embodiment of the method of driving the liquid crystal display panel of the invention. In this embodiment, the gate-on voltage in the main scanning period A is set to be higher than the gate-on voltage during the pre-scanning period B. In other respects, the driving method is the same as the driving method illustrated in FIG. 2.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

In this embodiment, further, though the main scanning period A is shorter than a horizontal scanning period, the gate-on voltage in the main scanning period A is set to be higher than the gate-on voltage in the pre-scanning period B. Therefore, the writing is effected at a high speed and to a sufficient degree in the main scanning period A. Even from this point of view, the writing efficiency is enhanced.

Here, the gate-off voltage between the pre-scanning period B and the main scanning period A may be set to be higher than the gate-off voltage during the data voltage-holding period after the main scanning period A.

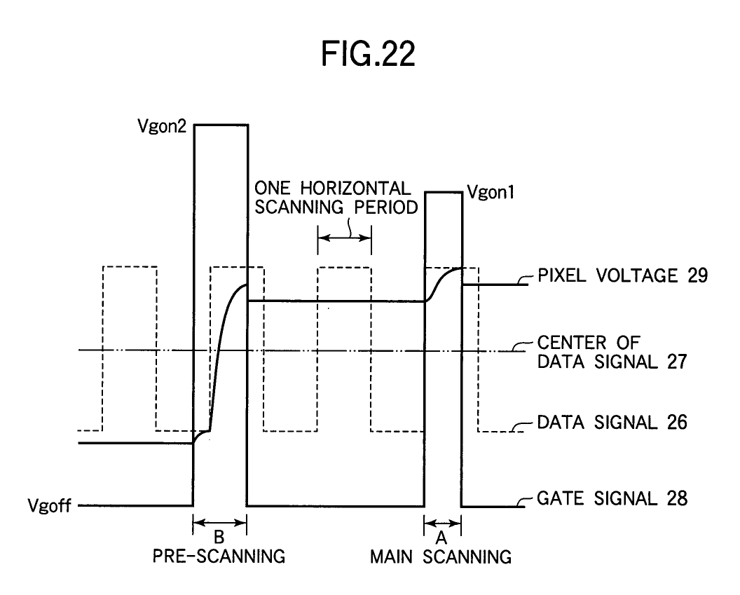

### Tenth Embodiment of the Method of Driving the Liquid Crystal Display Panel of the Invention: FIG. 22

FIG. 22 is a diagram of voltage waveforms illustrating a tenth embodiment of the method of driving the liquid crystal display panel of the invention. In this embodiment, the gate-on voltage in the pre-scanning period B is set to be higher than the gate-on voltage during the main scanning period A. In other respects, the driving method is the same as the driving method illustrated in FIG. 2.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

In this embodiment, further, though the main scanning period A is shorter than a horizontal scanning period, the gate-on voltage in the pre-scanning period B is set to be higher than the gate-on voltage in the main scanning period A. Therefore, the writing is effected at a high speed and to a sufficient degree in the pre-scanning period B. Even from this point of view, the writing efficiency is enhanced.

Here, the gate-off voltage between the pre-scanning period B and the main scanning period A may be set to be higher than the gate-off voltage during the data voltage-holding period after the main scanning period A.

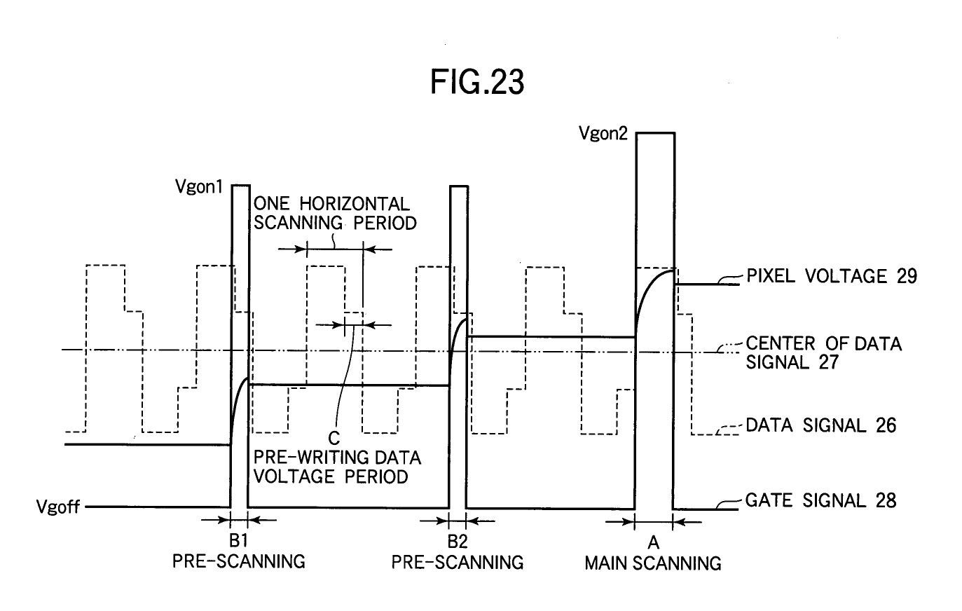

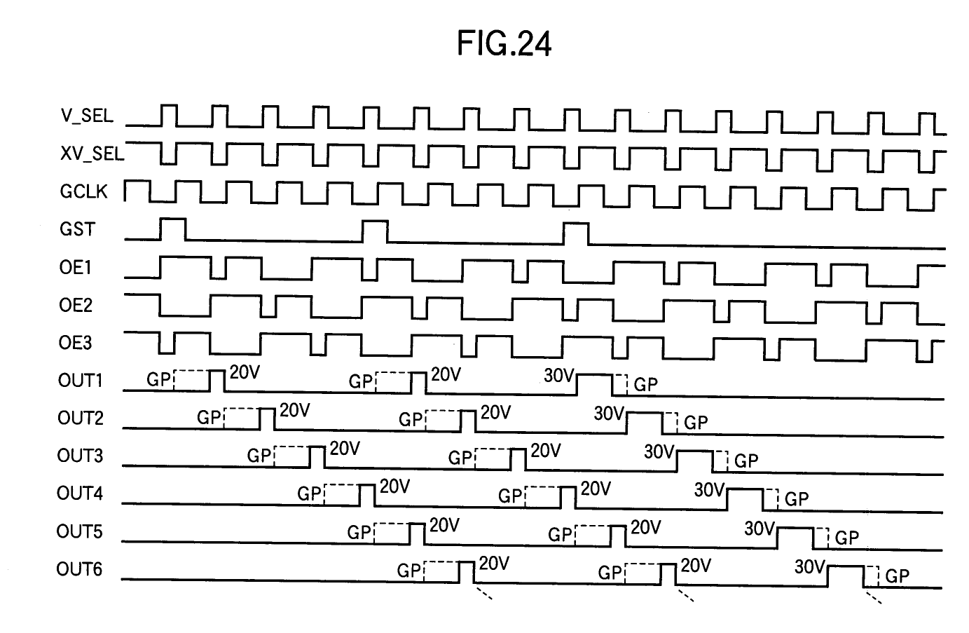

### Eleventh Embodiment of the Method of Driving the Liquid Crystal Display Panel of the Invention: FIGS. 23 and 24

FIG. 23 is a diagram of voltage waveforms illustrating an eleventh embodiment of the method of driving the liquid crystal display panel of the invention. In this embodiment, the gate-on voltage in the main scanning period A is set to be higher than the gate-on voltage during the pre-scanning period B. In other respects, the driving method is the same as the driving method illustrated in FIG. 9.

According to this embodiment, the gate signal 28 is raised simultaneously with the data signal 26 in the main scanning. Therefore, the pre-writing data voltage is not affected no matter what voltage is assumed by the data signal 26 in the vertical direction of one pixel before. As a result, the effect of pre-writing is sufficiently utilized to improve the writing efficiency without being accompanied by an increase in the process load or the cost.

In this embodiment, further, though the main scanning period A is shorter than a horizontal scanning period, the gate-on voltage in the main scanning period A is set to be higher than the gate-on voltage in the pre-scanning period B. Therefore, the writing is effected at a high speed and to a sufficient degree in the main scanning period A. Even from this point of view, the writing efficiency is enhanced.

FIG. 24 is a diagram of voltage waveforms illustrating a method of generating gate signals used in the embodiment, wherein symbols V_SEL and XV_CLK denote gate-on voltage change-over signals fed to the gate-on voltage change-over circuit 32 from the timing-generating circuit 31, symbols GCLK, GST and OE1 to OE3 denote signals fed to the gate drive circuit 22 from the timing-generating circuit 31, GCLK being a gate clock signal, GST being a start signal and OE1 to OE3 being output enable signals. OUT1 to OUT6 denote gate signals 28 output onto the gate lines of first horizontal line up to sixth horizontal line.

Namely, in this embodiment, the gate drive circuit 22 produces three gate signal-generating signals GP maintaining an interval of three horizontal scanning periods and being delayed by a horizontal period behind the gate signal-generating signals GP of the preceding horizontal lines, the gate signal-generating signals GP being corresponded to the first, second, - - - and m-th (e.g., 1200) horizontal lines, having an H-level voltage as a gate-on voltage (30 V) and having an H-level pulse width as a period of the gate clock signal GCLK. Here, however, the first and second gate signal-generating signals GP have a gate-on voltage Vgon1 (e.g., 20 V) and the third gate signal-generating signal GP has a gate-on voltage Vgon2 (e.g., 30 V).

In the first, fourth, - - - and 3N+1 horizontal lines, the H-level of the gate signal-generating signals GP is set to be Vgoff using the H-level of the output enable signal OE1 to thereby generate the gate signals 28. In the second, fifth, - - - and 3N+2 horizontal lines, the H-level of the gate signal-generating signals GP is set to be Vgoff using the H-level of the output enable signal OE2 to thereby generate the gate signals 28. In the third, sixth, - - - and 3N+3 horizontal lines, the H-level of the gate signal-generating signals GP is set to be Vgoff using the H-level of the output enable signal OE3 to thereby generate the gate signals 28.

In the method of driving the liquid crystal display panel according to the first to eleventh embodiments of the present invention, the polarity of the data signal is changed for every horizontal scanning period (dot inversion drive method, transverse inversion drive method). The method of driving the liquid crystal display panel of the invention, however, can be applied to the frame inversion drive method, too.

As described above, according to the present invention, the gate signal in the main scanning rises at a timing on or after a timing at which the data signal varies. Therefore, the pre-writing data voltage is not affected no matter what voltage is assumed by the data signal in the vertical direction of one pixel before. Therefore, the effect of pre-writing is fully utilized ,the writing efficiency is improved without being accompanied by an increase in the process load or the cost and superior display characteristics can be obtained.

What is claimed is:

1. A method of driving an active matrix type liquid crystal display panel, comprising the step of:
performing a pre-scanning and a main scanning to each horizontal line;
wherein a gate signal is raised in the main scanning at a timing on or after a timing at which a data signal is varied.

2. A method of driving a liquid crystal display panel according to claim 1, wherein the timing for raising the gate signal relative to the data signal in the pre-scanning is the same as the timing for raising the gate signal relative to the data signal in the main scanning.

3. A method of driving an active matrix type liquid crystal display panel, comprising the step of:
performing a pre-scanning and a main scanning to each horizontal line;
wherein an on-voltage of a gate signal in the pre-scanning is different from an on-voltage of the gate signal in the main scanning.

4. A method of driving an active matrix type liquid crystal display panel, comprising the step of:
performing a pre-scanning and a main scanning to each horizontal line;
wherein a length of the pre-scanning period is different from a length of the main scanning period.

5. A method of driving an active matrix type liquid crystal display panel, comprising the step of:
performing a pre-scanning and a main scanning to each horizontal line;
wherein a predetermined period in one scanning period is allocated to a pre-writing data voltage period, and a data voltage in the pre-writing data voltage period is used as a predetermined pre-writing data voltage.

6. A method of driving a liquid crystal display panel according to claim 5, wherein the predetermined pre-writing data voltage is the one of an intermediate gray scale.

7. A method of driving a liquid crystal display panel according to claim 5, wherein the predetermined pre-writing data voltage is the one between a white voltage and a black voltage of the same polarity as the polarity of the data signals in the main scanning.

8. A method of driving a liquid crystal display panel according to claim 5, wherein the predetermined pre-writing data voltage is an average gray scale voltage in a frame period for pixels along the data line.

9. A method of driving a liquid crystal display panel according to claim 5, wherein the predetermined pre-writing data voltage is the one during a main scanning period when the pre-scanning is just preceding the main scanning.

10. A method of driving a liquid crystal display panel according to claim 5, wherein the pre-writing data voltage is a voltage that is corrected by an amount of change in a pixel voltage stemming from the break-down of the gate signal at the end of the pre-scanning.

11. A method of driving an active matrix type liquid crystal display panel, comprising the step of:
performing a pre-scanning and a main scanning to each horizontal line;
wherein a gate-off voltage between the pre-scanning period and the main scanning period is set to be higher than the gate-off voltage after the main scanning period.

12. An active matrix type liquid crystal display panel comprising a drive circuit driven by a method of driving a liquid crystal display panel according to claim 1.
